(19) United States
(12) Patent Application Publication
(10) Pub. No.: US 2014/0105592 A1
(43) Pub. Date: Apr. 17, 2014

(54) System and Method of Redundancy in Network Communications

(71) Applicants: Deepak Kataria, Bridgewater, NJ (US); Jian-lin Mu, Ramsey, NJ (US); Michael Green, Central Valley, NY (US); John Brian Pipe, Allen, TX (US)

(72) Inventors: Deepak Kataria, Bridgewater, NJ (US); Jian-lin Mu, Ramsey, NJ (US); Michael Green, Central Valley, NY (US); John Brian Pipe, Allen, TX (US)

(21) Appl. No.: 13/652,156

(22) Filed: Oct. 15, 2012

(51) Int. Cl. H04B 10/08

(52) U.S. Cl. 398/2

(57) ABSTRACT

The present disclosure includes a network element comprising a first card configured to receive a duplicatively split first signal comprising a data component and a management component, and further configured to receive and transmit a duplicatively split second signal, and a similar second card. The network element also includes a selector configured to select either the first card or the second card to receive the management component of the first signal and to detect a change in designation between the first card and the second card to transmit the second signal. The selector is also configured to modify the selection to select the card designated to transmit the second signal to also receive the management component of the first signal. The disclosure also includes associated methods and systems.

### TECHNICAL FIELD

The present disclosure is related to network communication systems, and more particularly, to system and methods of optimizing redundancy in network communications.

### BACKGROUND

Telecommunications systems, cable television systems, and data communication networks use optical networks to rapidly convey large amounts of information between remote points. In an optical network, information is conveyed in the form of optical signals through optical fibers. Optical fibers comprise thin strands of glass capable of communicating the signals over long distances with very low loss. Optical networks often employ redundancies to maximize performance and availability.

Defects may occur within network systems. The term defect may refer to any error, problem, situation, mechanical failure, electrical failure, hardware failure, or software failure which may negatively affect the ability of the network system to carry a signal. For example, a defect may be a break in an optical fiber that may disrupt the flow of a signal along its path.

Redundancy may be employed to provide some protection against defects. One example of redundancy is alternative paths for communication between two network nodes. In a system with multiple paths, one method of redundancy is to have an active, or working path and a standby, or protect path. If some error or defect occurs on the active or working path, the system may transition to using the standby or protect path to carry signals. In a bi-directional switching scheme, if a defect or error is detected in either direction of communication, both directions of communication are switched from the active or working path to the standby or protect path.

### SUMMARY

In accordance with teachings of the present disclosure, one embodiment includes a method including selecting a first card of a first network element to receive a management component of a first signal, the first signal comprising the management component and a data component, the first signal being duplicatively split such that the first card and a second card receive the first signal, the first signal being sent from a client to the first network element, the first network element further configured to transmit the first signal to a second network element. The method also includes designating the first card to transmit a second signal, the second signal being received from the second network element, the first network element configured to transmit the second signal to the client. The method additionally includes detecting a change in the designation from the first card to the second card to transmit the second signal. The method further includes determining whether the second card is operable to receive the management component. Based on a determination that the second card is operable to receive the management component, the method also includes selecting the second card to receive the management component of the first signal.

Other embodiments of the present disclosure include a network element comprising a first card configured to receive a duplicatively split first signal comprising a data component and a management component, and further configured to receive and transmit a duplicatively split second signal. The network element further includes a second card configured to receive the duplicatively split first signal comprising a data component and a management component, and further configured to receive and transmit the duplicatively split second signal. The network element also includes a selector configured to select either the first card or the second card to receive the management component of the first signal. The selector is further configured to detect a change in designation between the first card and the second card to transmit the second signal. The selector is also configured to determine whether the card designated to transmit the second signal is operable to receive the management component of the first signal. The selector is configured to, based on a determination that the card designated to transmit the second signal is operable to receive the management component, modify the selection to select the card designated to transmit the second signal to receive the management component of the first signal.

An additional embodiment of the present disclosure includes a system comprising a first client comprising a first client transmitter and a first client receiver for communicating a first signal comprising a data component and a management component. The system also includes a near network element (NNE) comprising a first NNE card configured to receive and transmit the first signal, and further configured to receive and transmit a second signal. The NNE also includes a second NNE card configured to receive and transmit the first signal, and further configured to receive and transmit the second signal. The NNE further includes a selector configured to select either the first NNE card or the second NNE card to receive the management component of the first signal. The selector is further configured to detect a change in designation between the first NNE card and the second NNE card to transmit the second signal. The selector is additionally configured to determine whether the NNE card designated to transmit the second signal is operable to receive the management component of the first signal. The selector is also configured to, based on a determination that the NNE card designated to transmit the second signal is operable to receive the management component, modify the selection to select the NNE card designated to transmit the second signal to receive the management component of the first signal. The system further includes a far network element (FNE) comprising a first FNE card configured to receive and transmit the first signal, and further configured to receive and transmit the second signal and a second FNE card configured to receive and transmit the first signal, and further configured to receive and transmit the second signal. The system additionally includes a second client configured to receive the first signal and transmit the second signal. In the system, the first signal is configured to travel from the first client to the second client and the second signal is configured to travel from the second client to the first client.

The object and advantages of the invention will be realized and attained by means of at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 depicts a network in accordance with the present disclosure.

FIG. 2 depicts an embodiment of the present disclosure showing communication paths between a client and a network element.

FIG. 3A depicts an embodiment of the present disclosure in which a defect is detected.

FIG. 3B depicts an embodiment of the present disclosure when a defect is cleared.

FIG. 3C depicts an embodiment of the present disclosure when a defect is cleared.

FIG. 4A-4C depict embodiments of the present disclosure in which a defect is detected.

FIG. 5 depicts a flowchart according to one embodiment of the present disclosure.

FIG. 6 depicts a flowchart of an alternative embodiment of the present disclosure.

FIG. 7 depicts a flowchart of an alternative embodiment of the present disclosure.

### DETAILED DESCRIPTION

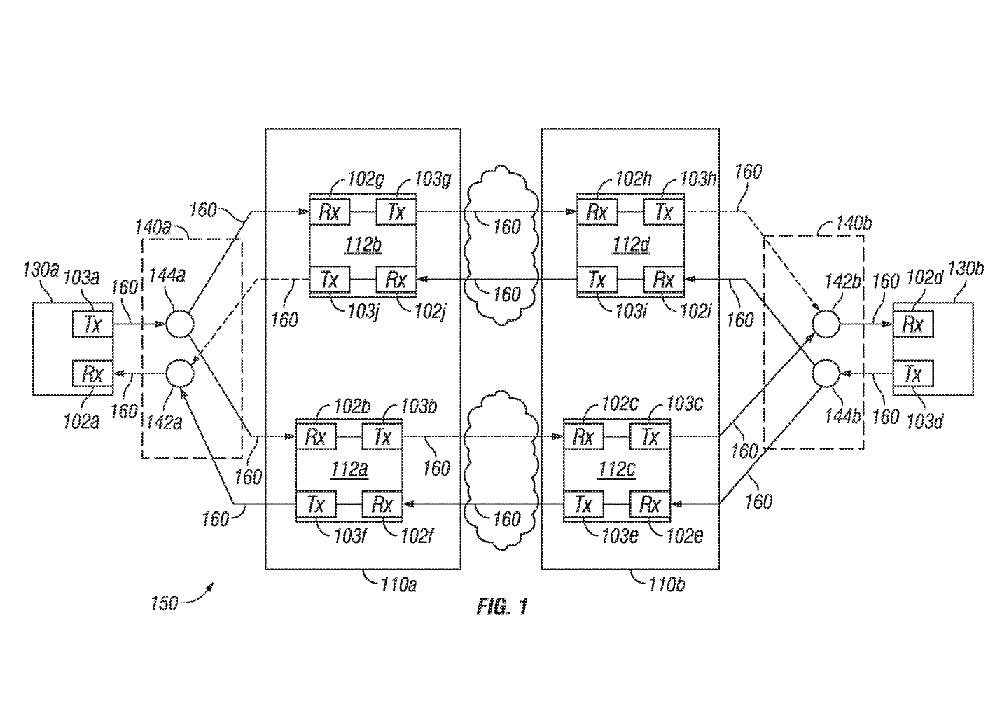

Embodiments of the present disclosure and its advantages are best understood by reference to FIGS. 1-7 wherein like numbers refer to same and like parts.

FIG. 1 illustrates a network in accordance with the present disclosure. In certain embodiments, network 150 may comprise a network configured to provide for communication of packets and/or frames via synchronous optical networking (SONET). In other embodiments, network 150 may comprise a network configured to provide for Ethernet datagram communication via Optical Transport Network (OTN). In some embodiments, a client side of network 150 may use Ethernet, SONET, fiber channels, OTN, video signals, cable signals, digital signals, or any other signal able to be encapsulated in OTN or SONET. The client side of network 150 may be understood to include communication between a client 130 and a network element 110. In other embodiments, a network side of network 150 may use OTN or SONET. The network side of network 150 may be understood to include communication between network elements 110. Other embodiments may include any other suitable data communicated using any other suitable network protocol for network 150. Network 150 may include one or more transmission media operable to transport one or more signals communicated by components of network 150. The components of network 150, coupled together by transmission media 160, may include a plurality of network elements 110, for example, near network element 110a and far network element 110b. Network 150 may be used in a short-haul metropolitan network, a long-haul inter-city network, or any other suitable network or combination of networks. It will be appreciated that the terms “near” and “far” as used in this disclosure are merely for convenience and are in no way limiting or descriptive of an actual location. For example, the terms “near” and “far” might just as easily be substituted with “first” and “second,” and are merely used to facilitate understanding of the present disclosure.

Each transmission medium 160 may include any system, device, or apparatus configured to communicatively couple network elements 110 to each other, and/or clients 130, and communicate information between network elements 110 and clients 130. For example, a transmission medium 160 may include an optical fiber, an Ethernet cable, a T1 cable, a WiFi signal, a Bluetooth signal, or other suitable medium. When the term receiver is used, it will be appreciated that this refers to any component operable to act as an interface between a transmission medium 160 and a network element 110 and/or client 130 and operable to receive a signal transmitted over a transmission medium 160. In like manner, a transmitter refers to any component operable to act as an interface between a transmission medium 160 and a network element 110 and/or client 130 and operable to transmit a signal over a transmission medium 160.

Network 150 may further communicate information or “traffic” over transmission media 160. As used herein, “traffic” means information transmitted, stored, or sorted in network 150. Such traffic may comprise optical or electrical signals configured to encode audio, video, textual, and/or any other suitable data. The data may also be real-time or non-real-time. Traffic may be communicated via any suitable communications protocol. Additionally, the traffic communicated in network 150 may be structured in any appropriate manner including, but not limited to, being structured in frames, packets, or an unstructured bit stream. As used herein, the term “datagram” may refer to a frame, packet, or other data structure for transmission of traffic.

Network 150 may further include any system configured to switch, forward, and/or route traffic between network elements 110. Network 150 may comprise a plurality of optical nodes each configured to provide switching, forwarding, and/or routing functionality.

It will be appreciated that network elements 110 in network 150, for example near network element 110a and far network element 110b, may comprise any suitable system operable to transmit and receive traffic. In the illustrated embodiment, the network elements 110 may be operable to transmit traffic directly to one or more other network elements 110 and receive traffic directly from the one or more other network elements 110. Further, network elements 110 may communicate to each other over any of a variety of paths over network 150. In certain embodiments, a network element 110 may perform datagram segmentation, reassembly, and other tasks in order to convert Ethernet packets received from clients 130 to frames (e.g., SONET or OTN frames) for communication over network 150, and vice versa. For example, a client 130 may transmit an Ethernet packet to a network element 110, which then may perform datagram segmentation, reassembly, and other tasks to convert the Ethernet packet into SONET frames. In another non-limiting example, the client 130 may transmit a SONET frame to the network element 110 and the network element 110 may perform tasks in order to be able to transmit the same datagram as an OTN frame.

Traffic may be originated at a desired client 130. Each client has a transmitter 103 to transmit traffic and a receiver 102 to receive traffic. In certain embodiments, this traffic is Ethernet traffic that is sent optically from and received optically by clients 130. Clients 130 may be coupled to network elements 110 via y-cables 140. Y-cable 140 includes a splitter 144 configured to split traffic into two flows in one direction of traffic flow and a combiner 142 configured to combine two flows of traffic into a single path in the other direction of traffic flow. For example, when y-cable 140 is coupled to client 130 it splits traffic originating at client 130 into two flows and combines traffic to be received by client 130 into a single flow. This may provide redundancy in network 150 by providing multiple paths for traffic flow despite originating from or being passed to a single client 130. In some embodiments, network 150 may include y-cable 140a coupling near client 130a to near network element 110a, and may further include y-cable 140b coupling far client 130b to far network element 110b.

Near network element 110a may include multiple cards 112, for example, a first card 112a and a second card 112b. When referring to a card 112, it will be appreciated that a card 112 may be a physical component carrying or housing related components and/or features. Alternatively, a card 112 may be a logical grouping of related components and/or features without necessarily having physical proximity. A card 112 may include the components described below, but may further include other components including logic, memory, or combinations thereof. Card 112a may include two corresponding sets of receivers and transmitters, receiver 102b and transmitter 103b and receiver 102f and transmitter 103f Receivers 102 and transmitters 103 may be optical receivers and transmitters. Card 112b may also include two corresponding sets of receivers and transmitters, receiver 102g and transmitter 103g and receiver 102j and transmitter 103j. By providing two cards, redundant equipment is provided in case of any defects, malfunctions, or errors with equipment by providing two potential paths traffic may flow along. This provides the basis for using y-cable 140, as two cards 112 are able to receive the two flows of traffic split by y-cable 140. Cards 112a and 112b need not have two sets of transmitters/receivers. For example, card 112a might have one receiver 102 and one transmitter 103 that are operable to convey information both from and to near client 130a and far network element 110b. Alternatively, card 112a might have multiple sets of transmitters/receivers, even beyond two. Additionally, in some embodiments, more than two cards 112 may be used.

Similarly, far network element 110b may include multiple cards, for example, a first card 112c and a second card 112d. Card 112c may include two corresponding sets of receivers and transmitters, receiver 102c and transmitter 103c and receiver 102e and transmitter 103e. Card 112d may also include two corresponding sets of receivers and transmitters, receiver 102h and transmitter 103h and receiver 102i and transmitter 103i. As described above with respect to cards 112a and 112b, cards 112c and 112d need not be limited to two sets of transmitters/receivers. Far client 130b may also include a receiver 102d and transmitter 103d.

FIG. 1 further depicts a variety of exemplary paths of signals among network 150, designated by the heavy arrows. While FIG. 1 depicts connections directly connecting near network element 110a and far network element 110b, it will be appreciated that any number of paths may be employed, including paths among different network elements, different networks, different medium, or any other feature of network 150 described above. Thus, the connections between network elements 110a and 110b are merely used for convenience in describing the disclosure, and are in no way limited to such direct connections.

For traffic to be communicated from near client 130a to far client 130b, near client 130a transmits a signal from transmitter 103a to splitter 144a within y-cable 140a. The signal may then be split into a first and second portion and both portions of the signal may be transmitted to cards 112a and 112b of near network element 110a. For example, the signal may be duplicatively split such that the first and second portions are identical. Card 112a receives the first portion of the split signal at receiver 102b and transmits the first portion of the split signal via transmitter 103b to far network element 110b. Card 112b receives the second portion of the split signal via receiver 102g and transmits the second portion via transmitter 103g to far network element 110b. In some embodiments, the cards 112 receive SONET frames and transmit OTN frames to far network element 110b. In other embodiments, the cards 112 receive OTN frames and transmit SONET frames to far network element 110b. In other embodiments, the cards 112 may receive and transmit the same frame type. For example, cards 112 may receive and transmit SONET frames or may receive and transmit OTN frames.

Receiver 102c of card 112c of far network element 110b receives the first portion of the signal transmitted from transmitter 103b. Receiver 102h of card 112d of far network element 110b receives the second portion of the signal transmitted from transmitter 103g. Far network element 110b selects one of card 112d or card 112c to transmit the received signal to receiver 102d of far client 130b. This may be transmitted via y-cable 140b through combiner 142b.

Signals flow in a similar manner from far client 130b to near client 130a through far network element 110b cards 112d and 112c. Far client 130b transmits a signal from transmitter 103d to splitter 144b within y-cable 140b. The signal may then be split into a first and second component and both components of the signal may be transmitted to cards 112c and 112d of far network element 110b. Card 112c receives a first portion of the split signal at receiver 102e and transmits the portion of the split signal via transmitter 103e to near network element 110a. Card 112d receives a second portion of the split signal via receiver 102i and transmits the portion via transmitter 103i to near network element 110a. Receiver 102f of card 112a of near network element 110a receives the first portion of the signal transmitted from transmitter 103e. Receiver 102j of card 112b of near network element 110a receives the second portion of the signal transmitted from transmitter 103i. Near network element 110a selects one of card 112b or card 112a to transmit the received signal to receiver 102a of near client 130a. This may be transmitted via y-cable 140a through combiner 142a.

In a y-cable protection scheme, y-cable 140 allows for a redundant path of traffic between points within network 150. When a defect occurs in one traffic flow path, network 150 may employ one of the alternative traffic paths to protect and maintain the data flow between points within network 150. This may be accomplished by switching between cards 112 within a network element 110 as described below.

In a bi-directional switching scheme, any defect detected in either active path flowing from near client 130a to far client 130b or from far client 130b to near client 130a causes both near network element 110a and far network element 110b to switch which card is used to transmit the signal. In other words, in a bi-directional switching scheme, there are two bi-directional paths to be used, and a fault in either direction uses the protection for both directions. Thus any further protection is lost for both directions until the defect can be repaired or cleared. Further, the switching may occur at an end where no defect has occurred, unnecessarily causing a break in the connection between the client 130 and the network element 110.

It will be appreciated that selecting and switching as described in the present disclosure may be performed by logic and/or memory associated with a network element 110 and/or client 130. Further switching may include physically powering or not powering a component; ignoring signals, traffic, or data from a component; gathering or listening to signals, traffic, or data from a component; or disabling or enabling certain aspects, features, or sub-components of a component.

In uni-directional y-cable data protection switching schemes, cards 112 may be switched based on a defect in a particular direction of the traffic flow, providing more robust protection by having separate protection for each flow direction. In particular, traffic originating at client 130a is split at y-cable 140a and flows along both paths until it is to be passed to y-cable 140b at which point only one of cards 112c and 112d actually transmits the traffic to client 130b via y-cable 140b. Any defect along the redundant traffic flow path that passes through card 112c (the card 112 actually transmitting the traffic) may result in network element 110b switching which card 112 actually transmits the traffic from card 112c to card 112d, effectively switching to the alternative traffic flow path for this traffic flow direction. This only causes a switch for the traffic flow in one direction. This occurs separate and distinct from any switching done in the opposite flow direction. In like manner, for traffic flowing the opposite direction, similar protection is provided. In some instances, a defect, for example a fiber breaking, may result in both network elements 110a and 110b switching cards 112, but they are switched independently. One potential problem with uni-directional y-cable data protection switching schemes is that it switches at the end opposite from where the traffic is originated, which does not address potential problems in maintaining the connection between the originating client 130 and network element 110. A bi-directional y-cable data protection switching scheme is described in further detail below.

With regards to traffic flowing from near client 130a to far client 130b, if a defect were to occur in traffic flowing between near client 130a and splitter 144a, for example, if splitter 144a of y-cable 140a or transmitter 103a of near client 130a was defective, no action would be taken. If a defect were to occur between splitter 144a and receiver 102b, for example, if receiver 102b was defective or transmission medium 160 between splitter 144a and receiver 102b were defective, far network element 110b would be informed that a defect occurred. Far network element 110b would select card 112d to transmit the signal, rather than card 112c, with no regard to where along the path the defect occurred. In like manner, if a defect were to occur between transmitter 103b and receiver 102c, for example if transmitter 103b or receiver 102c were defective, far network element 110b would be informed that a defect occurred. Far network element 110b would select card 112d to transmit the signal, rather than card 112c. Similarly, if a defect were to occur between transmitter 103c and combiner 142b, for example, if transmitter 103c was defective, far client 130b would inform far network element 110b that it did not receive the signal. Far network element 110b would select card 112d to transmit the signal, rather than card 112c. This may provide protection for signals transmitted from near client 130a to far client 130b by switching at far network element 110b. Further, this may allow switching to occur in only one direction, thus maintaining the redundancy in the other direction despite having already employed switching in one direction. However, this switching occurs at far network element 110b, regardless of where along the redundant traffic flow path the defect occurs.

With regard to signals travelling from far client 130b to near client 130a, if a defect were to occur between far client 130b and splitter 144b, no action would be taken. If a defect were to occur between splitter 144b and receiver 102e, near client 130a would inform near network element 110a that it did not receive the signal. Near network element 110a would select card 112b to transmit the signal, rather than card 112a. In like manner, if a defect were to occur between transmitter 103e and receiver 102f, near network element 110a would be informed that a defect occurred. Near network element 110a would select card 112b to transmit the signal, rather than card 112a. Similarly, if a defect were to occur between transmitter 103f and combiner 142a, near network element 110a would be informed that a defect occurred. Near network element 110a would select card 112b to transmit the signal, rather than card 112a. This may provide protection for signals transmitted from far client 130b to near client 130a by switching at near network element 110a. Further, as described above, this may allow switching to occur in only one direction.

In revertive systems, once a defect has been cleared, a network element may switch back to an initially selected card for transmitting a signal. For example, if card 112c was initially transmitting the signal and card 112d was selected due to a defect, when the defect is cleared, card 112c would again be selected to transmit the signal. In a non-revertive system, rather than reverting to card 112c to transmit the signal upon clearing a defect, card 112d would continue to transmit the signal.

In some embodiments of the present disclosure, a network element 110a may be configured to provide uni-directional switching, i.e. switching that can be done for only one direction of traffic flow, at the near end based on defects associated with receiving a management component of a signal originating from near client 130a in order to maintain the connection between client 130a and network element 110a. This is in contrast to y-cable data protection schemes which would switch cards 112 at far network element 110b for traffic originating at client 130a.

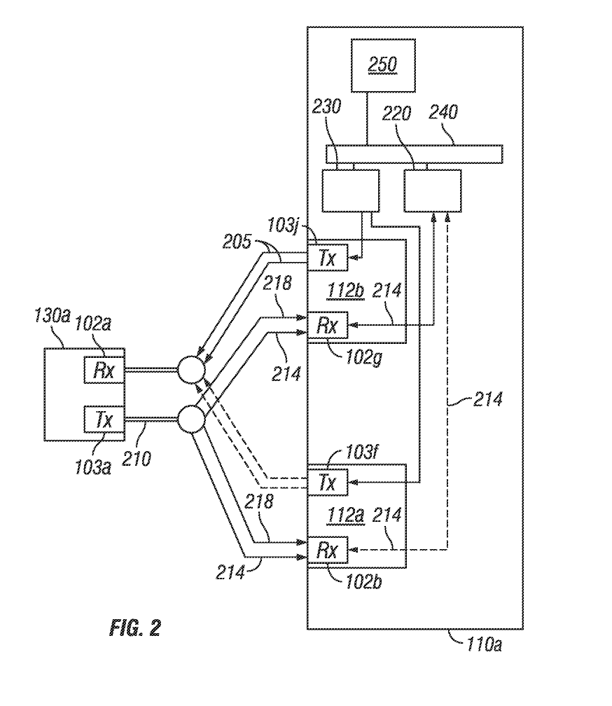

FIG. 2 illustrates an embodiment of the present disclosure showing communication paths between client 130a and network element 110a. A signal 210 sent from near client 130a to network element 110a may have a management component 214 and a data component 218. In some embodiments using SONET, the management component may include data communication channel (DCC) for a variety of optical carrier transmission rates (OCn), or alternatively some embodiments using OTN may include general communication channel (GCC) for a variety of optical channel transport units (OTUk). Management component may further comprise any data set used for carrying management data, for example, and in no way limiting, parameters of the signal, parameters of network connections, parameters of network operation, or any combinations thereof. For example, the management component may be used to maintain the connection between near client 130a and near network element 110a such that a break in the transmission of the management component between near client 130a and near network element 110a may require reinitialization of the connection between client 130a and near network element 110a.

When signal 210 is split at splitter 144a, both management component 214 and data component 218 are sent to receiver 102b of card 112a and receiver 102g of card 112b. In some embodiments, near network element 110a further includes a selector 220 configured to select one of receiver 102b of card 112a and receiver 102g of card 112b to receive management component 214 of signal 210. Thus, rather than only switching at far network element 110b if a defect occurs as described in bi-directional y-cable data protection schemes, the present disclosure contemplates that near network element 110a may switch which card 112 is relied on for treatment of the management component 214. Selector 220 may switch which receiver 102 is receiving management component 214, despite not switching which card's 112 transmitter 103 is transmitting the data component for signals 205 coming from far client 130b to near client 130a. In other words, transmitter 103 switching of near network element 110a is based on defects of transmission paths from far client 130b towards near client 130a. However, receiver 102 switching at near network element 110a is possible via selector 220. This may facilitate more rapid switching between cards 112 at the near end when a defect occurs. In some embodiments, this may completely prevent loss in connection between near client 130a and near network element 110a. In other embodiments, this may prevent some, but not all, of the times in which the connection between near client 130a and near network element 110a would be interrupted.

It will be appreciated that selector 220 may be any component configured to select and/or switch between locations designated to receive a signal. Selector 220 may further include logic and/or memory to facilitate the selection.

The same protection at near network element 110a may also be present for signals transmitted from far client 130b via far network element 110b. For example, far network element 110b may also be configured with a selector for selecting between card 112c and card 112d to receive the management component of a signal.

In some embodiments, near network element 110a may further include a bridge 230 configured to provide a signal to card 112a and 112b. In addition, near network element may comprise a data control channel (DCC) subsystem 240 communicatively coupled to bridge 230 and selector 220. DCC subsystem may communicate the received management component 214 to an element management system (EMS) 250. EMS 250 may be configured to facilitate network communication and/or network maintenance and assist in management of network element 110a. DCC and EMS may be involved in the routing and processing of management component 214. This routing may be done according to a routing protocol. In some embodiments, data component 218 does not follow a routing protocol. Bridge 230 may be configured to receive management component 214 from EMS 250 and send it to both cards 112a and 112b for communication to client 130a. In some embodiments, selector 220, bridge 230, and DCC subsystem 240 may be a single component configured to perform each of the functions of the respective elements. This single component may comprise logic and memory to facilitate the performance of these functions.

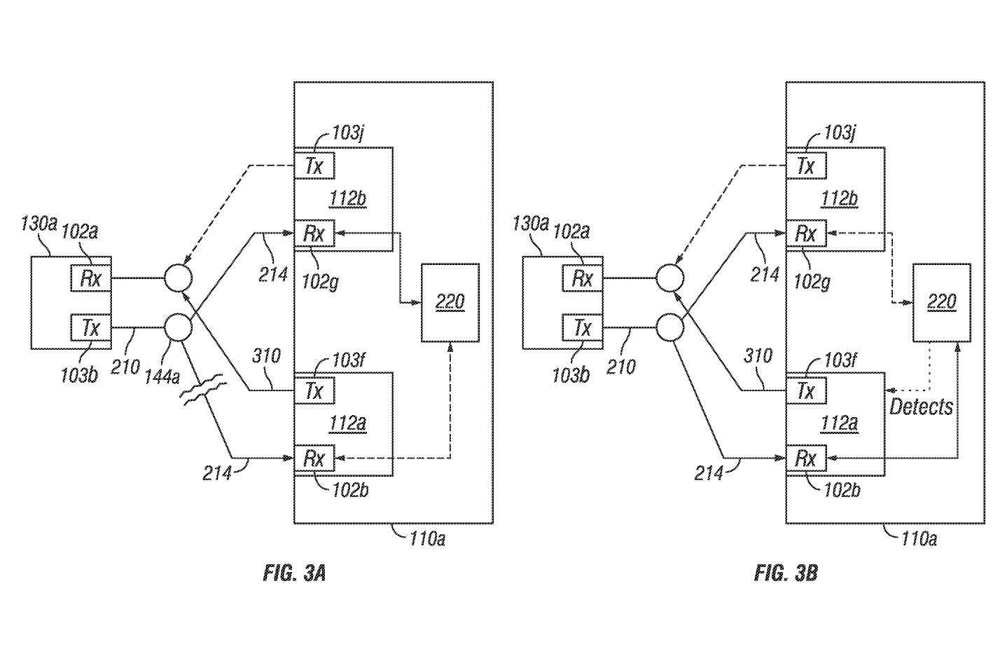

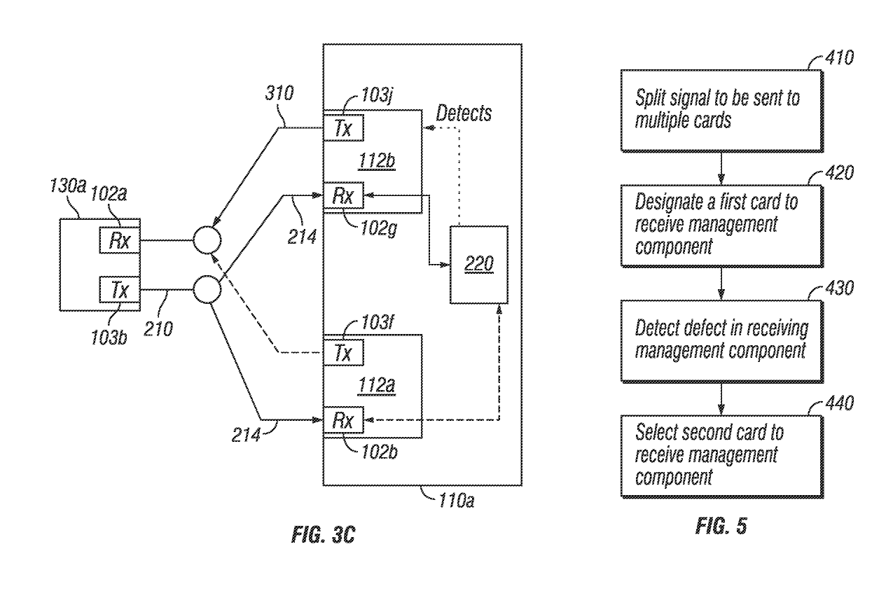

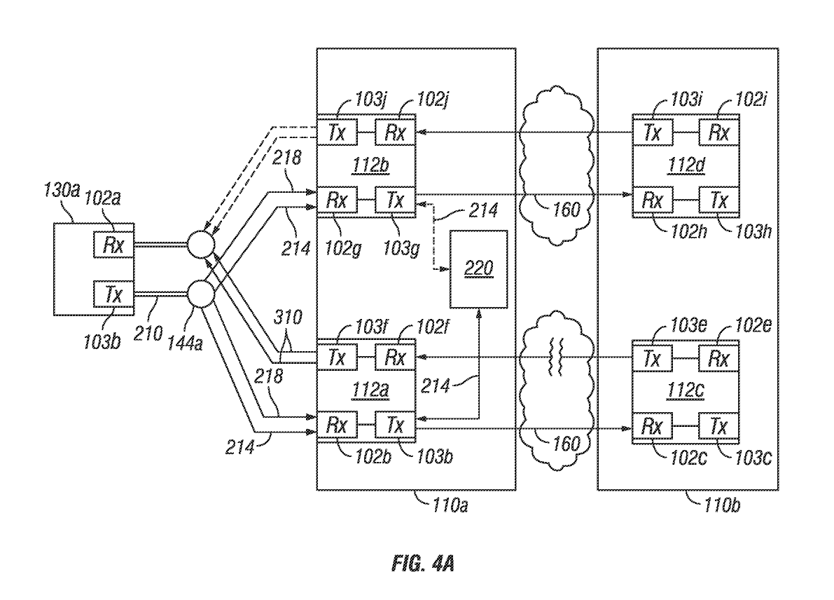

FIGS. 3A through 3C illustrate aspects of the present disclosure when defects are detected and then cleared. In some embodiments of the present disclosure, near network element 110a may be configured with a dynamic revertive system. Some defects may only affect data component 218 of signal 210 and other defects may only affect management component 214. For example, as shown in FIG. 3A, if a defect occurs between splitter 144a and receiver 102b, selector 220 may select receiver 102g of card 112b to receive the management signal. Additionally, far network element 110b may switch from card 112c to card 112d to transmit signal 210 to far client 130b. However, as can be seen in FIG. 3A, card 112a is still active to transmit any signals 310 from far client 130b to near client 130a as there has been no defect along transmission path from far client 130b to near client 130a. This is the case as transmitter switching is based on flow originating at far client 130b. Thus, both cards 112a and 112b are actively being used in near network element 110a. Once the defect clears, selector 220 may further determine whether card 112a or card 112b is currently active to transmit signals 310 to near client 130a. If card 112a is active, selector 220 will revert to receiver 102b of card 112a to receive management component 214 of signal 210, as shown in FIG. 3B. However, if card 112b is active to transmit signals 310 to near client 130a, selector 220 will continue to employ card 112b to receive management component 214 of signal 210, as shown in FIG. 3C. In this way, the amount of time when only one of card 112a or card 112b may be employed for both receiving and transmitting of signals may be maximized. This may facilitate ease in changing cards or servicing a network element without disrupting network connections.

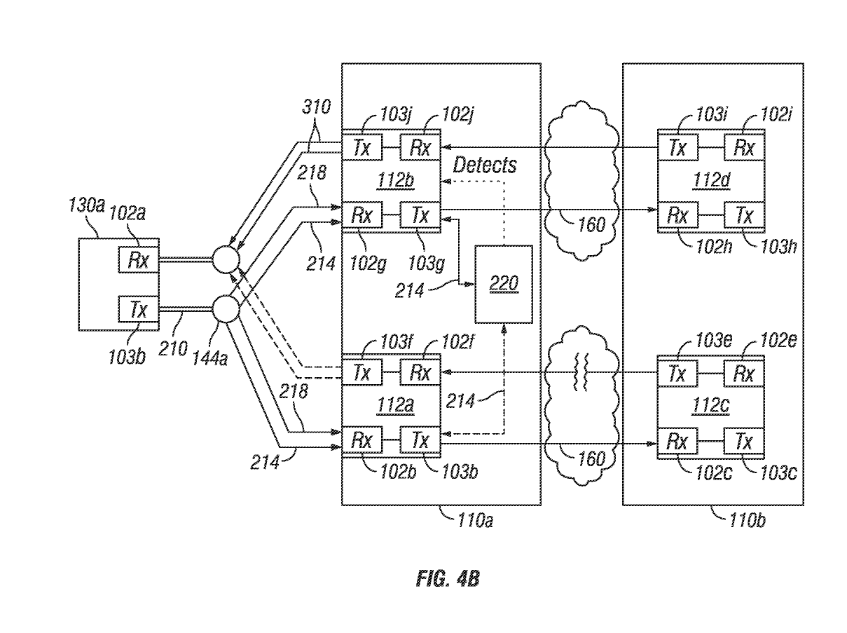

FIGS. 4A through 4C illustrate aspects of the present disclosure when defects occur and a selector is employed. In some embodiments, a defect may occur such that a card 112 receiving management component 214 need not necessarily switch to an alternate card 112, but it may be beneficial to do so. For example, as shown in FIG. 4A, a defect may occur between transmitter 103e and receiver 102f. In some embodiments, this defect may be in the transmission of a data component of a signal from far network element 110b to near network element 110a. As described previously, this defect may cause near network element 110a to switch from card 112a to card 112b in transmitting a signal to near client 130a. As shown in FIG. 4B, selector 220 may detect that card 112b has been selected to transmit any signals 310 from far client 130b to near client 130a. Selector 220 may then determine whether card 112b is operable to receive management component 214 of the signal. If card 112b is operable to receive management component 214, selector 220 may then select card 112b and receiver 102g to receive management component 214 of signal 210. This switching may occur despite the lack of any defect associated with transmission or reception of management component 214 occurring. If card 112b is not operable to receive management component 214, selector 220 may be prevented from switching to card 112b.

Alternatively, as shown in FIG. 4C, a defect may occur between transmitter 103i and receiver 102j. If card 112a is already employed to transmit any signals 310 from far client 130b to near client 130a, selector 220 may continue to employ card 112a to receive management component 214 of signal 210. Alternatively, if card 112b is employed to transmit any signals 310 from far client 130b to near client 130a when a defect occurs between transmitter 103i and receiver 102j, card 112a may be selected instead to transmit any signals 310 from far client 130b to near client 130a. In response, selector 220 may select card 112a to receive management component 214 of signal 210. This switching may occur despite the lack of any defect associated with transmission or reception of management component 214.

In some embodiments, upon clearing of a defect, network element 110a might switch back to the card 112 that was originally designated to transmit any signals 310 from far client 130b to near client 130a. Selector 220 may then determine whether the card 112 reverted to is operable to receive the management component 112. If the card 112 is operable, selector 220 may then cause the management component 112 to follow the card 112 that is used to transmit any signals 310 from far client 130b to near client 130a. However, if the card 112 is not operable, selector 220 may be prevented from switching which card receives management component 214.

The switching shown in FIGS. 4B and 4C may occur regardless of any switching that occurs at far network element 110b. A variety of factors may be used in determining whether a card 112 is operable to receive management component 112. Any defect associated with the management component may prevent switching. For example, in some situations, if one of receivers 102g or 102b are defective, selector 220 may not switch to their respective cards. Alternatively, in some embodiments, a user might make a designation preventing selector 220 from switching between cards 112.

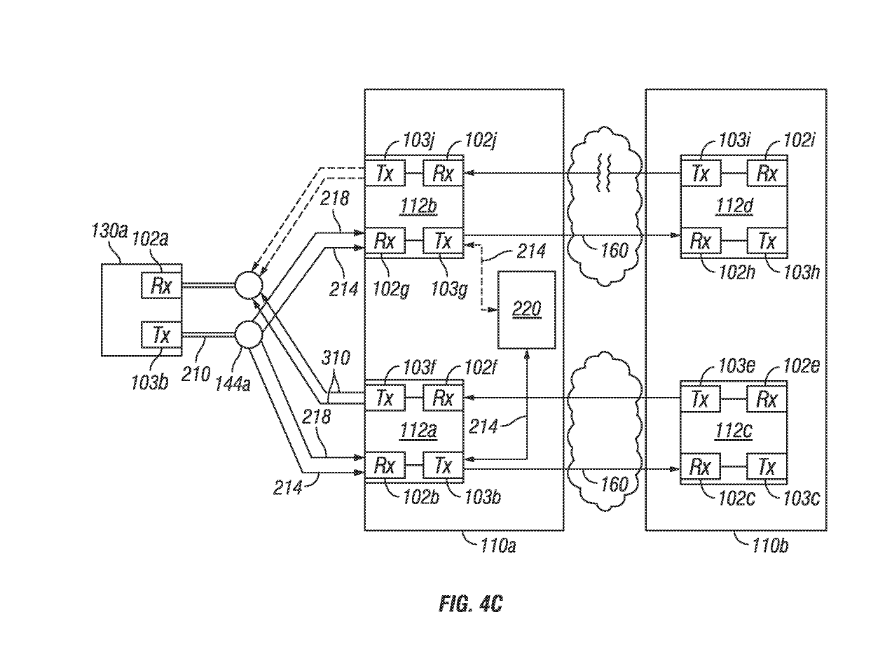

Methods in accordance with the present disclosure are shown in FIGS. 5 through 7. These methods may be described in terms of two cards within a network element, but are not so limited. For example, they could be employed in a distributed system with cards in different locations, or in a system with more than two cards. FIG. 5 illustrates a flowchart according to one embodiment of the present disclosure. At operation 410, a signal is split such that it can be sent duplicatively to two cards within a network element. As described above, the signal may include a management component and a data component. At operation 420, the first card is designated by the network element to receive the management component of the signal. At operation 430, a defect is detected by the network element in receiving the management component at the designated card. At operation 440, the second card is selected by the network element to receive the management component of the signal.

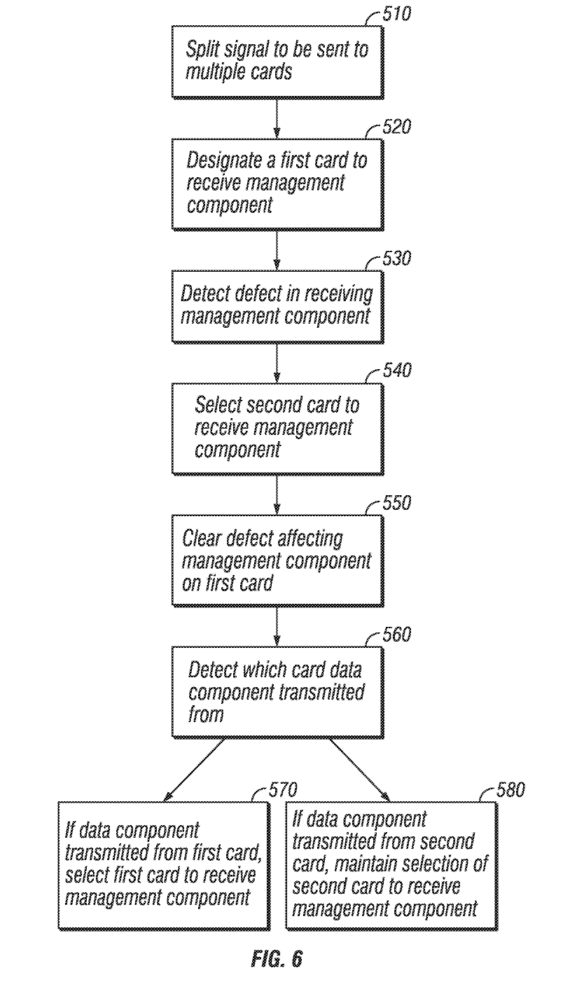

FIG. 6 illustrates an alternative method in accordance with the present disclosure. At operation 510, a signal is split such that it can be sent duplicatively to two cards within a network element. As described above, the signal may include a management component and a data component. At operation 520, the first card is designated by the network element to receive the management component of the signal. At operation 530, a defect is detected by the network element in receiving the management component at the designated card. At operation 540, the second card is selected by the network element to receive the management component of the signal. At operation 550, the defect affecting the first card receiving the management component is cleared such that the first card would be operable to again receive the management component. At operation 560, the network element detects which of the cards is active to transmit the data component in the same direction the management component is received from. Based on this determination, at operation 570, if the first card is active to transmit the data component, the network element selects the first card to also receive the management component. Alternatively, at operation 580, based on the determination of operation 560, if the second card is active to transmit the data component, the network element will continue to select the second card to receive the management component. In this way a dynamic reversion may be accomplished in which network element does not revert the operation of a card according to a fixed physical location, but instead makes a determination and reverts according to external factors. In some embodiments, this external factor may be which card is transmitting the data component of the signal.

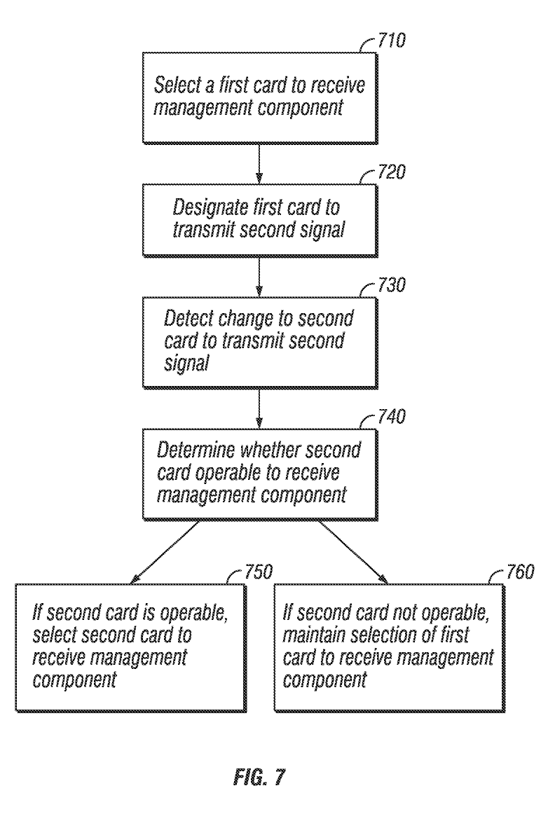

FIG. 7 illustrates an alternative embodiment in accordance with the present disclosure. At operation 710, a first card of a first network element is selected to receive a management component of a first signal. The first signal is sent from a client to the first network element and includes both a data component and a management component. At operation 720, the first card is designated by the network element to transmit a second signal. The second signal is received from a second network element. The selection and designation at operations 710 and 720 may be done during initialization of the first network element, or by a user selection or designation, or may be triggered by some event or automated process. At operation 730, a change in the network element is detected that switches from the first card transmitting the second signal to the second card transmitting the second signal. This may occur due to a defect. This may occur between a client and a network element, or some point between two network elements. At operation 740, a determination is made whether the second card is operable to receive the management component. As described above, a defect or a user designation are two examples that may prevent the second card from being operable to receive the management component. Based on this determination, at operation 750, if the second card is operable to receive the management component, the selector switches to the second card to both transmit the second signal and to receive the management component. Alternatively, at operation 760, based on the determination of operation 740, if the second card is not operable to receive the management component, the network element will maintain the selection of the first card to receive the management component.

The above described disclosure may maximize the number of times in which receiver 102 and transmitter 103, which may be switched independently of each other, are on the same card 112. This may further be shown with reference to TABLES 1 and 2. TABLE 1 shows management protection without dynamic reversion. In this table, T represents an operable state and F represents a defective state. It can be seen that in line numbers 7, 9, 10, 14, and 15, the management channel and data channel are on different cards.

TABLE 1

| | Rx | Tx | Rx | Tx | Manage- | Y-Cable |
|---|---|---|---|---|---|---|
| | Working | Working | Passive | Passive | ment | Data |
| | Path | Path | Path | Path | Channel | Protection |
| No. | State | State | State | State | Switch | Switch |
| 1 | T | T | T | T | NO | NO |
| 2 | T | T | T | F | NO | NO |
| 3 | T | T | F | T | NO | NO |
| 4 | T | T | F | F | NO | NO |
| 5 | T | F | T | T | YES | YES |
| 6 | T | F | T | F | NO | NO |
| 7 | T | F | F | T | NO | YES |
| 8 | T | F | F | F | NO | NO |
| 9 | F | T | T | T | YES | NO |
| 10 | F | T | T | F | YES | NO |
| 11 | F | T | F | T | NO | NO |
| 12 | F | T | F | F | NO | NO |
| 13 | F | F | T | T | YES | YES |
| 14 | F | F | T | F | YES | NO |
| 15 | F | F | F | T | NO | YES |
| 16 | F | F | F | F | NO | NO |

TABLE 2 shows management protection with dynamic reversion as described in the present disclosure. In the column headings, column 1 contains a line number, column 2 contains the status of the transmitter in the working (or active) pathway, column 3 contains the status of the transmitter in the passive (or protect) pathway, column 4 contains the status of the working receiver, column 5 contains the status of the passive receiver, columns 6-9 contains the line number the system will transition to if T×W, T×P, R×W, or R×P, respectively, changes states. In the second through fifth columns, the terms OC represents operational and carrying traffic, ON represents operational and not carrying traffic, and F represents a defective state.

TABLE 2

| | | | | | | TxP | RxW | RxP |
|---|---|---|---|---|---|---|---|---|
| No. | TxW | TxP | RxW | RxP | TxW Transition | Transition | Transition | Transition |
| 1 | OC | ON | OC | ON | GO TO 10 | GO TO 2 | GO TO 12 | GO TO 4 |
| 2 | OC | F | OC | ON | GO TO 3 | GO TO 1 | GO TO 13 | GO TO 5 |
| 3 | F | F | OC | ON | GO TO 2 | GO TO 10 | GO TO 16 | GO TO 8 |
| 4 | OC | ON | OC | F | GO TO 7 | GO TO 5 | GO TO 17 | GO TO 1 |
| 5 | OC | F | OC | F | GO TO 8 | GO TO 4 | GO TO 18 | GO TO 2 |
| 6 | ON | OC | OC | F | GO TO 7 | GO TO 5 | GO TO 19 | GO TO 9 |
| 7 | F | OC | OC | F | GO TO 6 | GO TO 8 | GO TO 20 | GO TO 10 |
| 8 | F | F | OC | F | GO TO 5 | GO TO 7 | GO TO 21 | GO TO 3 |
| 9 | ON | OC | ON | OC | GO TO 10 | GO TO 2 | GO TO 14 | GO TO 6 |
| 10 | F | OC | ON | OC | GO TO 9 | GO TO 11 | GO TO 15 | GO TO 7 |
| 11 | F | F | ON | OC | GO TO 2 | GO TO 10 | GO TO 16 | GO TO 8 |
| 12 | OC | ON | F | OC | GO TO 15 | GO TO 13 | GO TO 1 | GO TO 17 |
| 13 | OC | F | F | OC | GO TO 16 | GO TO 12 | GO TO 2 | GO TO 18 |
| 14 | ON | OC | F | OC | GO TO 15 | GO TO 13 | GO TO 9 | GO TO 19 |
| 15 | F | OC | F | OC | GO TO 14 | GO TO 16 | GO TO 10 | GO TO 20 |
| 16 | F | F | F | OC | GO TO 13 | GO TO 15 | GO TO 11 | GO TO 21 |
| 17 | OC | ON | F | F | GO TO 20 | GO TO 18 | GO TO 4 | GO TO 14 |
| 18 | OC | F | F | F | GO TO 21 | GO TO 17 | GO TO 5 | GO TO 13 |
| 19 | ON | OC | F | F | GO TO 20 | GO TO 18 | GO TO 6 | GO TO 14 |
| 20 | F | OC | F | F | GO TO 19 | GO TO 21 | GO TO 7 | GO TO 15 |
| 21 | F | F | F | F | GO TO 18 | GO TO 20 | GO TO 8 | GO TO 16 |

Modifications, additions, or omissions may be made to network 150 without departing from the scope of the disclosure. The components of network 150 may be integrated or separated. Moreover, the operations of network 150 may be performed by more, fewer, or other components. Additionally, operations of network 150 may be performed using any suitable logic. As used in this document, “each” refers to each member of a set or each member of a subset of a set.

Logic may include hardware, software, and/or other logic. Logic may be encoded in one or more tangible computer readable storage media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions has been described in detail, it should be understood that the various changes, substitutions, and alterations could be made hereto without departing from the spirit and scope of the invention.

What is claimed is:

1. A method comprising:
selecting a first card of a first network element to receive a management component of a first signal, the first signal comprising the management component and a data component, the first signal being duplicatively split such that the first card and a second card receive, based on a selection, the management component and the data component of the first signal, the first signal being sent from a client to the first network element, the first network element configured to transmit the first signal to a second network element;
designating the first card to transmit a second signal, the second signal being received from the second network element, the first network element configured to transmit the second signal to the client;
detecting a change in the designation from the first card to the second card to transmit the second signal;
determining whether the second card is operable to receive the management component; and
based on a determination that the second card is operable to receive the management component, selecting the second card to receive the management component of the first signal.

2. A method according to claim 1, wherein selecting the second card to receive the management component of the first signal is performed when no defect associated with the management component has occurred.

3. A method according to claim 1, further comprising:
detecting a defect in receiving the second signal by the first card; and
based on the detected defect, designating the second card to transmit the second signal.

4. A method according to claim 1, wherein the data component and the management component of the first signal are transmitted optically.

5. A method according to claim 3, wherein the second signal comprises a management component and a data component, and the defect is associated with the data component of the second signal.

6. A method according to claim 3, wherein the defect is associated with a component of the first card.

7. A method according to claim 3, wherein the defect is associated with a transmission line upon which the second signal would travel.

8. A method according to claim 1, further comprising based on a determination that the second card is not operable to receive the management component, maintaining the designation of the first card to receive the management component of the first signal.

9. A method according to claim 8, wherein the second card is not operable due to a defect associated with the second card.

10. A method according to claim 8, wherein the second card is not operable due to a user designation to prevent switching from the first to the second card.

11. A network element comprising:
a first card configured to receive a duplicatively split first signal comprising a data component and a management component, and further configured to receive and transmit a duplicatively split second signal;
a second card configured to receive the duplicatively split first signal comprising a data component and a management component, and further configured to receive and transmit the duplicatively split second signal; and
a selector configured to select either the first card or the second card to receive the management component of the first signal, the selector further configured to:
detect a change in designation between the first card and the second card to transmit the second signal;
determine whether the card designated to transmit the second signal is operable to receive the management component of the first signal; and
based on a determination that the card designated to transmit the second signal is operable to receive the management component, modify the selection to select the card designated to transmit the second signal to receive the management component of the first signal.

12. A network element according to claim 11, wherein the selector is configured to prevent switching to a card that is determined not to be operable to receive the management component of the first signal.

13. A network element according to claim 11, wherein the operability of the first or the second cards is determined by a defect associated with the first or the second card.

14. A network element according to claim 11, wherein the operability of the first or the second cards is determined by a designation by a user.

15. A network element according to claim 11, wherein the selector is configured to modify the selection even when no defect associated with the management component of the first signal has occurred.

16. A system comprising:
a first client comprising a first client transmitter and a first client receiver for communicating a first signal comprising a data component and a management component;
a near network element (NNE) comprising:
a first NNE card configured to receive and transmit the first signal, and further configured to receive and transmit a second signal;
a second NNE card configured to receive and transmit the first signal, and further configured to receive and transmit the second signal; and
a selector configured to select either the first NNE card or the second NNE card to receive the management component of the first signal, the selector further configured to:
detect a change in designation between the first NNE card and the second NNE card to transmit the second signal;
determine whether the NNE card designated to transmit the second signal is operable to receive the management component of the first signal; and
based on a determination that the NNE card designated to transmit the second signal is operable to receive the management component, modify the selection to select the NNE card designated to transmit the second signal to receive the management component of the first signal;
a far network element (FNE) comprising:
a first FNE card configured to receive and transmit the first signal, and further configured to receive and transmit the second signal; and
a second FNE card configured to receive and transmit the first signal, and further configured to receive and transmit the second signal; and
a second client configured to receive the first signal and transmit the second signal;
wherein the first signal is configured to travel from the first client to the second client and the second signal is configured to travel from the second client to the first client.

17. A system according to claim 16, wherein the selector is configured to prevent switching to a NNE card that is determined not to be operable to receive the management component of the first signal.

18. A system according to claim 16, wherein the operability of the first or the second NNE cards is determined by a defect associated with the first or the second NNE card.

19. A system according to claim 16, wherein the operability of the first or the second NNE cards is determined by a designation by a user.

20. A system according to claim 16, wherein the selector is configured to modify the selection even when no defect associated with the management component of the first signal has occurred.
